(19) United States
(12) Patent Application Publication
(10) Pub. No.: US 2026/0235512 A1
(43) Pub. Date: Aug. 13, 2026

(54) RETRO-REFLECTION MEASUREMENT METHOD AND DEVICE

(71) Applicant: EVERFINE (Shenzhen) Precise Measurement Tech Co., Ltd., Guangdong (CN)

(72) Inventors: Jiangen PAN, Guangdong (CN); Yingying WEN, Guangdong (CN); Xinyi ZHAN, Guangdong (CN); Qian LI, Guangdong (CN)

(73) Assignee: EVERFINE (Shenzhen) Precise Measurement Tech Co., Ltd., Guangdong (CN)

(21) Appl. No.: 19/340,909

(22) Filed: Sep. 26, 2025

(30) Foreign Application Priority Data
Feb. 8, 2025 (CN) 202510138819.2

(51) Int. Cl. G01N 21/55; G01N 21/17

(52) U.S. Cl. CPC G01N 21/55; G01N 2021/1772; G01N 2021/551; G01N 2201/0636; G01N 2201/0646; G01N 2201/0662; G01N 2201/12746

(57) ABSTRACT

The present invention discloses a retro-reflection measurement method, including the following steps: S1: uniformly illuminating, by a directional light source, a measured sample, and receiving, by an array detector, retro-reflected light from the measured sample, to obtain retro-reflected light distribution; S2: calculating, based on the light distribution, a retro-reflection luminescence intensity that varies with an observation angle, including: enabling position coordinates of a pixel in the array detector to be corresponding to the observation angle of retro-reflection, enabling a pixel response value of the array detector to be corresponding to the retro-reflection luminescence intensity, and then calculating a retro-reflection parameter of the measured sample at a specified observation angle. In the present invention, correspondences between a pixel, an angle, and a luminescence intensity are established, so that efficient conversion from light distribution data to a retro-reflection parameter is implemented.

### CROSS-REFERENCE TO RELATED APPLICATION

This application claims priority to Chinese Patent Application No. 202510138819.2, filed on February 8, 2025. The entirety of the above–mentioned patent applications is hereby incorporated by reference herein and made a part of this specification.

### FIELD OF TECHNOLOGY

The present invention relates to the field of retro-reflection measurement, and in particular to a retro-reflection measurement method and device.

### BACKGROUND

Materials with a good reflective property, especially a good retro-reflection property, are widely used in automobiles, motor vehicles, warning signs, and the like, and play a key role in road traffic and personal safety. A reflection property or the retro-reflection property is a key technical indicator of this type of materials, and is of great significance to effective measurement. Because measurement of the retro-reflection property of the materials needs to be performed in a direction in which an incident optical path and a receiving optical path coincide or are very close to each other, which is extremely difficult to be performed technically. No effective apparatus or method suitable for measuring optical properties of retro-reflectors or materials has been provided so far.

A traditional retro-reflection measurement optical path is shown in FIG. 1. A standard light source A illuminates a measured sample at a specific irradiation angle, and a light detector receives retro-reflection light emitted by the measured sample at a specific observation angle (namely, an included angle between an illumination axis and an observation axis), to implement the measurement of a photometric characteristic of a retro-reflective material or the retro-reflector. The observation angle is usually 2° or below. Therefore, optical path lengths of an illumination optical path and a reflection optical path in this method are long, and an optical signal of the retro-reflected light reaching the detector is extremely weak, and it is difficult to measure a spectral characteristic of the material. Moreover, the above retro-reflection measurement needs to be performed in extremely large darkroom space, which is only suitable for photometric measurement requirements of a laboratory, and cannot meet requirements of industrial production lines and on-site rapid measurement.

### SUMMARY

To overcome shortcomings in the prior art, the present invention provides a retro-reflection measurement method, to resolve problems of inaccurate retro-reflection measurement caused by a long optical path and weak optical signal in traditional measurement methods, and a difficulty in meeting industrial and on-site rapid measurement requirements, thereby quickly and efficiently implementing accurate measurement of optical properties of a retro-reflection material.

To achieve the above technical objective, the present invention provides a retro-reflection measurement method, including the following steps:

S1: Uniformly illuminating, by a directional light source, a measured sample, and receiving, by an array detector, retro-reflected light from the measured sample, to obtain retro-reflected light distribution; and

S2: Calculating, based on the light distribution, a retro-reflection luminescence intensity that varies with an observation angle, including: enabling position coordinates of a pixel in the array detector to be corresponding to the observation angle of retro-reflection, enabling a pixel response value of the array detector to be corresponding to the retro-reflection luminescence intensity, and then calculating a retro-reflection parameter of the measured sample at a specified observation angle.

In the above technical solution, a directional light source with a specific aperture angle is used, which means that light emitted by the light source is limited to a specific angle range, ensuring that the light illuminating the measured sample has good directionality and consistency. A high-resolution array detector (such as a CMOS or CCD two-dimensional planar array detector) is used to capture light distribution generated by the retro-reflection of the measured sample, a size of a single pixel in the array detector can reach a micrometer level, and light intensity information of a plurality of pixels can be recorded simultaneously. Measurement values of the plurality of pixels can be accumulated and calculated together (also known as a macro mode), greatly improving the efficiency and resolution of light distribution data acquisition. Specifically, a correspondence between the position coordinates of the pixel in the array detector and the observation angle of the retro-reflection, as well as an accurate correspondence between the pixel response value and the retro-reflection luminescence intensity can be established through pre-calibration or design determining, which can implement precise measurement of a retro-reflection characteristic at a tiny observation angle. A tiny pixel unit in the array detector is used to implement extremely small angle control, without a long distance, and the measurement of the retro-reflected light distribution is also extremely precise. Further, other retro-reflection parameters of the measured sample at a specified observation angle can be derived and calculated based on the retro-reflection luminescence intensity, such as a retro-reflection luminescence intensity coefficient, a retro-reflection coefficient, and a retro-reflection brightness coefficient. In the present invention, correspondences between position coordinates of the pixel, an angle, and a luminescence intensity are innovatively established, achieving efficient conversion from light distribution data to a retro-reflection parameter. This not only simplifies a measurement process, but also improves the accuracy and reliability of a measurement result. This method does not rely on the long optical path and large darkroom environment, and can quickly and accurately obtain the retro-reflection parameter in a more flexible scenario, effectively meeting the needs of different measurement scenarios such as rapid measurement on industrial production lines and on-site rapid measurement.

Preferably, a light blocking component is also disposed between the array detector and the directional light source to prevent light beams emitted by the directional light source from being directly incident on the array detector, to further ensure the accuracy of a measurement result and prevent the influence of stray light. Not only light emitted from the light source illuminates the measured sample, but also some of the light may be directly incident on the array detector if no light blocking component is provided, thereby affecting a measurement result and increasing a measurement error. The light blocking component and the light source can be integrated in design, such as a directional LED lamp. The light blocking component is an optical reflection device in a lamp, which concentrates light beams emitted by a light source on the measured sample. Alternatively, the light blocking component and the light source are two separate structures. For example, the light blocking component is a mirror that reflects light emitted by the light source in a direction different from a direction of the measured sample, preventing light from being directly incident on the array detector.

In a technical solution, in step S1, the array detector is used to directly collect and measure the light distribution, and the array detector directly receives the retro-reflected light from the measured sample or receives the retro-reflected light from the measured sample through a mirror. Specifically, a pixel in the array detector receives the retro-reflected light of the measured sample. Preferably, a two-dimensional planar array detector is used with a cooling technology, which can significantly suppress thermal noise, have high pixel resolution, can capture weak signals, and improve measurement accuracy and resolution. Retro-reflected light beams are directly received through the pixel in the array detector, so that light intensity and information are maximally preserved, reducing energy loss during light transmission and improving a light utilization rate. Especially when weak retro-reflected light is measured, a light signal can be more effectively captured, measurement sensitivity can be enhanced, and a measurement result can more accurately reflect an optical characteristic of the sample. In some compact industrial sites or specific experimental devices, if the array detector cannot be placed in an ideal position facing the sample, the optical path can be changed through a reflector, to cleverly solve a problem of space limitation, ensuring that the array detector can effectively receive the retro-reflected light beams, improving the integration and compactness of an entire system, reducing an area occupied by the system, and enhancing the practicality and convenience of the device.

As further improvement of the above technical solution, in step S2, an average or weighted average of the retro-reflection luminescence intensity is taken within a specific aperture angle range around the specified observation angle, to obtain a retro-reflection luminescence intensity value at the specified observation angle; and other retro-reflection parameters are derived based on the retro-reflection luminescence intensity, including a retro-reflection luminescence intensity coefficient, a retro-reflection coefficient, and a retro-reflection brightness coefficient. In an actual measurement process, due to various factors such as micro unevenness of a sample surface, which may cause shining, and angular jumps caused by environmental noise, an unstable mechanical structure, and a detector accuracy problem, there may be some fluctuations in the retro-reflection luminescence intensity obtained at different pixel positions. An average or weighted average of the retro-reflection luminescence intensity is taken within a specific aperture angle range around a specified observation angle, which can effectively reduce a measurement error. A plurality of measurement values are integrated, so that a final retro-reflection luminescence intensity value obtained at the specified observation angle can better represent a true luminescence characteristic of the sample at the angle, thereby improving the stability, consistency, and reliability of a measurement result and meeting measurement needs of different samples.

In another technical solution, in step S1, the array detector is located in an imaging measurement unit, a diffusing screen is disposed in a retro-reflection optical path, retro-reflection light beams are irradiated onto the diffusing screen, and an imaging lens in the imaging measurement unit projects light spot information on the diffusing screen onto an image plane of the array detector. The diffusing screen is used to broaden an effective receiving range of the device for the retro-reflected light, which helps to obtain more comprehensive data on retro-reflected light distribution and reduce a measurement error. In addition, the light is evenly diffused due to the diffuse screen, and even if there is a slight deviation in the position of the array detector in the imaging measurement unit, a diffused spot image can be received relatively uniformly. This reduces strict requirements for installation position accuracy of the array detector, simplifies an assembly process of the device, and improves the stability and reliability of the device in use.

In a technical solution, in step S1, the directional light source emits light beams through a perforated mirror, and the light beams from the directional light source directly illuminate the measured sample or penetrate one or more mirrors and then illuminate the measured sample; retro-reflected light beams emitted from the measured sample are influenced by the perforated mirror, and are finally incident on the array detector. In this technical solution, optical path layout is optimized through the design of the perforated mirror. An illumination path from the directional light source to the measured sample and a measurement path from the measured sample to the array detector do not interfere with each other. The structure is simpler and more compact, to facilitate installation and use in different scenarios. An optical path trend is observed through deflection of the perforated mirror, which reduces the influence of external stray light and the loss of light compared with traditional long-distance measurement, improving the stability, reliability, and accuracy of measurement. The perforated mirror is corresponding to a measurement ring corresponding to a determined observation angle. Therefore, a ring light signal of the retro-reflected light of the measured sample can be received by the array detector, to complete retro-reflection at the specified observation angle. In addition, an angle or a position of the perforated mirror is adjusted to flexibly change a reflection path of light, thereby implementing the collection of retro-reflected light from different directions, providing the possibility for multi-angle measurement of a retro-reflection characteristic of the measured sample. The perforated mirror that meets a specific observation angle can be disposed based on measurement requirements, to complete the measurement of the retro-reflection characteristic of the ring light signal at the specified observation angle.

In a technical solution, in step 2, a correspondence between the position coordinates of the pixel in the array detector and the observation angle is calibrated through a spatial geometric positional relationship; a collimated light source (such as a laser or an LED collimated light source) is used to irradiate a position of the measured sample in reverse at one or more angles, where an angle formed between a light beam axis of the collimated light source and a light beam axis of the directional light source for illuminating the sample is known, and then a correspondence between the position coordinates of the pixel and the observation angle is calibrated based on a pixel response in the array detector; or a correspondence between the position coordinates of the pixel in the array detector and the observation angle is calibrated in combination with the two methods. Specifically, the position coordinates of and a relative angle relationship between the array detector, the measured sample, and the directional light source in space are measured through a measurement instrument (such as a three-coordinate measurement instrument, an imaging measurement device, or the like), principles of geometric optics and trigonometric geometry are used to calculate, for each pixel in the array detector, an angle between light reflected from the measured sample to the pixel and a light beam axis of the directional light source, namely, an observation angle, is calculated through a geometric model, so that a correspondence between position coordinates of each pixel in the array detector and the observation angle is established. Alternatively, a collimated light source can be used for reverse illumination and calibration. The collimated light source can be placed at a position of the measured sample, and an angle of the collimated light source is adjusted, to form a known specific angle between a light beam axis of the collimated light source and a light beam axis of the directional light source. The collimated light source can then be turned on to illuminate the array detector in reverse at one or more specific known angles. Due to good directionality of the collimated light source, the response of different pixels in the array detector reflects the incidence of light from different angles. Therefore, based on the response distribution of pixels in the array detector and a known collimated light source illumination angle, an observation angle corresponding to each pixel when receiving light can be determined. For example, if an angle formed between the light beam axis of the collimated light source and the light beam axis of the directional light source beam is known to be α, and a pixel in the array detector receives light from the light source, a correspondence between position coordinates of the pixel and the observation angle can be calibrated by analyzing a light propagation path and a geometric structure of the array detector. If a plurality of collimated light sources with different angles are used for reverse illumination, a more comprehensive and accurate correspondence can be obtained.

In another technical solution, step 2 further includes: using a standard light source with known spatial light intensity distribution to irradiate the position of the measured sample in reverse, forming a response on the array detector, and calibrating a response value of the pixel in the array detector based on a known light intensity value. Before actual measurement, the response of the array detector is calibrated using the standard light source with known light intensity distribution. The standard light source is placed at a position at which the measured sample is placed, and the standard light source is used for reverse irradiation and forms a response on the array detector. A response value of a pixel in the array detector is calibrated based on the known light intensity value, effectively correcting a pixel response error and further improving measurement accuracy and consistency. A calibrated array detector is used to measure a retro-reflection optical characteristic of the measured sample, and a measurement result obtained is relatively accurate.

In another technical solution, a sample of the same type with a known retro-reflection parameter is used as a standard sample, the standard sample is placed at the position of the measured sample, and the pixel response value of the array detector is calibrated based on a retro-reflection luminescence intensity of the standard sample. When a standard sample with a known retro-reflection parameter is used to replace the measured sample at a measurement position, retro-reflected light generated by the standard sample when illuminated by the directional light source is projected onto the array detector with specific intensity distribution, causing a corresponding response in each pixel in the array detector. Due to the known retro-reflection parameter (such as a retro-reflection luminescence intensity) of the standard sample, a reference standard is established. A pixel response value generated by the retro-reflected light of the standard sample in the array detector is measured, and the pixel response value is correlated with a known retro-reflection parameter, to determine a quantitative relationship between each pixel response value of the array detector and an actual retro-reflection luminescence intensity. This implements calibration of the pixel response value of the array detector and precise calibration of an entire measurement system, and improves measurement accuracy and reliability.

In a technical solution, an illumination angle formed between a normal of the measured sample and a light beam axis of the directional light source is adjustable, and the retro-reflection parameter is measured based on step S1 and step S2 at two or more illumination angles. Measurement at a single illumination angle may be affected by factors such as local unevenness of a sample surface and a measurement system error, resulting in a measurement result error. A retro-reflection parameter is measured and comprehensively analyzed at a plurality of illumination angles, and mutual verification and supplementation can be implemented, reducing errors caused by the local factors. In addition, an illumination angle is adjusted, so that light is incident on a surface of the measured sample at different angles, thereby stimulating different retro-reflection characteristics of the sample. The retro-reflection parameter is measured at two or more illumination angles, so that a reflection law of the sample towards light can be known from a plurality of angles. For example, some materials may present a unique optical characteristic at a specific illumination angle, such as an enhanced reflection intensity or special reflection angle distribution. Through comprehensive measurement, a micro-structure and optical anisotropy of a material can be analyzed more deeply, providing rich data support for material science research. In addition, retro-reflection parameters obtained at a plurality of illumination angles help to construct a more complete and accurate optical characteristic model of the sample.

The present invention further provides a retro-reflection measurement device, including a light shielding tube, where the light shielding tube is provided with a sampling opening for placing a measured sample, a directional light source and an array detector are disposed inside the light shielding tube, light beams emitted from the directional light source directionally illuminate the sampling opening, and the array detector is disposed on a retro-reflection optical path to receive retro-reflection optical beams of the measured sample.

In a technical solution, an imaging measurement unit and a diffusing screen are also disposed in the light shielding tube, where the diffusing screen is located on the retro-reflection optical path, the array detector is located in the imaging measurement unit, the imaging measurement unit further includes an imaging lens, the imaging measurement unit is disposed facing the diffusing screen, and the imaging lens images a light spot image on the diffusing screen into the array detector. The diffusing screen is designed to form a relatively large and uniform light spot on the diffusing screen, allowing the imaging measurement unit to capture information about the retro-reflected light within a larger range.

In a technical solution, inside the light shielding tube, a perforated mirror is disposed in front of the directional light source, light beams emitted by the directional light source are emitted through small holes in the perforated mirror, and the array detector is disposed on a reflection optical path of the perforated mirror. In the technical solution, optical path layout is optimized through the design of the perforated mirrors, so that an entire retro-reflection measurement device is structurally simpler and more compact, helping miniaturization and integration of the device and facilitating installation and use in different scenarios.

In a technical solution, one or more mirrors are further disposed on an optical path between the perforated mirror and the sampling opening, and the mirror is a plane mirror, a concave mirror, or a convex mirror. Light beams emitted from the directional light source sequentially penetrate small holes in a perforated mirror, are then reflected by one or more mirrors along a folded optical path, and are incident on the measured sample. The retro-reflected light influenced by the measured sample penetrates the one or more mirrors, and is finally incident on the array detector through the perforated mirror. The optical path is deflected through one or more mirrors, optimizing the optical path layout, avoiding interference between the optical path and other components, effectively saving internal space of the device, enabling the structure of the entire retro-reflection device to be more compact and reasonable, facilitating the miniaturized design and integrated assembly of the device, and meeting volume requirements of different application scenarios such as on-site measurement and industrial production lines.

In a technical solution, inside the light shielding tube, the directional light source is disposed between the array detector and the sampling opening, and a photosensitive unit of the array detector is disposed facing the sampling opening. The photosensitive unit of the array detector directly receives retro-reflected light from the measured sample. An observation angle formed between a detection surface of the array detector relative to the measured sample and the directional light source can be controlled to be an extremely angle through a tiny pixel unit of the array detector, without the need for an excessively long distance. In addition, measurement of retro-reflected light distribution is also extremely precise. The position coordinates of the pixel in the array detector can be corresponding to the observation angle of retro-reflection, and a pixel response value of the array detector can be corresponding to the retro-reflection luminescence intensity. Further, other retro-reflection parameters of the measured sample at a specified observation angle can be derived and calculated based on the retro-reflection luminescence intensity, such as a retro-reflection luminescence coefficient, a retro-reflection coefficient, and a retro-reflection brightness coefficient.

In a preferred technical solution, the retro-reflection measurement device includes two or more sample interfaces, one side of the sample interface is connected to the sampling opening, the measured sample is placed on the other side of the sample interface, and each sample interface is provided so that a different angle is formed between a normal of the measured sample and a light beam axis of the directional light source. Measurement is performed at different observation angles through different sample interfaces, and measurement needs of different types of samples can be met, greatly enhancing measurement flexibility and adaptability.

The present invention further provides another retro-reflection measurement device, including a rotating table, a directional light source, a diffusing screen, and an imaging measurement unit, where the imaging measurement unit includes an imaging lens and an array detector; the rotating table and the directional light source are relatively disposed in a darkroom; and a measured sample is installed on the rotating table, light beams emitted by the directional light source illuminate the measured sample, the diffusing screen receives retro-reflected light from the measured sample, and the imaging measurement unit faces the diffusing screen, where the imaging lens images light spots on the diffusing screen onto the array detector. The rotating table drives to change an illumination angle formed between a light beam axis of the directional light source and a normal of the measured sample, to further implement measurement of a retro-reflection characteristic of the measured sample at a specific incident angle.

In a technical solution, one or more mirrors are further included in an optical path from the directional light source to the measured sample, light beams emitted from the directional light source sequentially penetrate small holes in a perforated mirror, are then reflected by the one or more mirrors along a folded optical path, and are incident on the measured sample, and the retro-reflected light influenced by the measured sample penetrates the one or more mirrors, and is then incident on the diffusing screen through the perforated mirror. The optical path is deflected through one or more mirrors, optimizing the optical path layout, avoiding interference between the optical path and other components, effectively saving internal space of the device, enabling the structure of the entire retro-reflection device to be more compact and reasonable, facilitating the miniaturized design and integrated assembly of the device, and meeting volume requirements of different application scenarios such as on-site measurement and industrial production lines.

In a technical solution, a light blocking component is disposed between the diffusing screen and the directional light source to block light beams emitted by the directional light source from being directly incident on the diffusing screen; and a measurement field of view of the imaging measurement unit avoids the light beams emitted by the directional light source and collects only light spot information on the diffusing screen. The light blocking component is designed to prevent the influence of stray light and ensure the accuracy of a measurement result.

The present invention provides a retro-reflection measurement method and device. A measured sample is uniformly illuminated by a directional light source with a specific aperture angle, and an array detector is used to collect light distribution generated by the retro-reflection of the measured sample. Correspondences between position coordinates of the pixel, an angle, and a luminescence intensity are innovatively established, achieving efficient conversion from light distribution data to a retro-reflection parameter. This not only simplifies a measurement process, but also improves the accuracy and reliability of a measurement result. This method and device does not rely on the long optical path and large darkroom environment, and can quickly and accurately obtain the retro-reflection parameter in a more flexible scenario, effectively meeting the needs of different measurement scenarios such as rapid measurement in laboratories and industrial production lines, and on-site rapid measurement, and featuring characteristics of a simple optical path, high measurement accuracy, a fast measurement speed, easy operation, and low costs.

### BRIEF DESCRIPTION OF THE DRAWINGS

FIG. 1 is a schematic diagram of an existing retro-reflection measurement optical path.

FIG. 2 is a schematic structural diagram of a retro-reflection measurement device in a first embodiment.

FIG. 3 is a schematic structural diagram of a retro-reflection measurement device in a second embodiment.

FIG. 4 is a schematic structural diagram of a retro-reflection measurement device in a third embodiment.

FIG. 5 is a schematic structural diagram of a retro-reflection measurement device in a fourth embodiment.

FIG. 6 is a schematic structural diagram of a retro-reflection measurement device in a fifth embodiment.

FIG. 7 is a schematic structural diagram of a retro-reflection measurement device in a sixth embodiment.

FIG. 8 is a schematic structural diagram of a retro-reflection measurement device in a seventh embodiment.

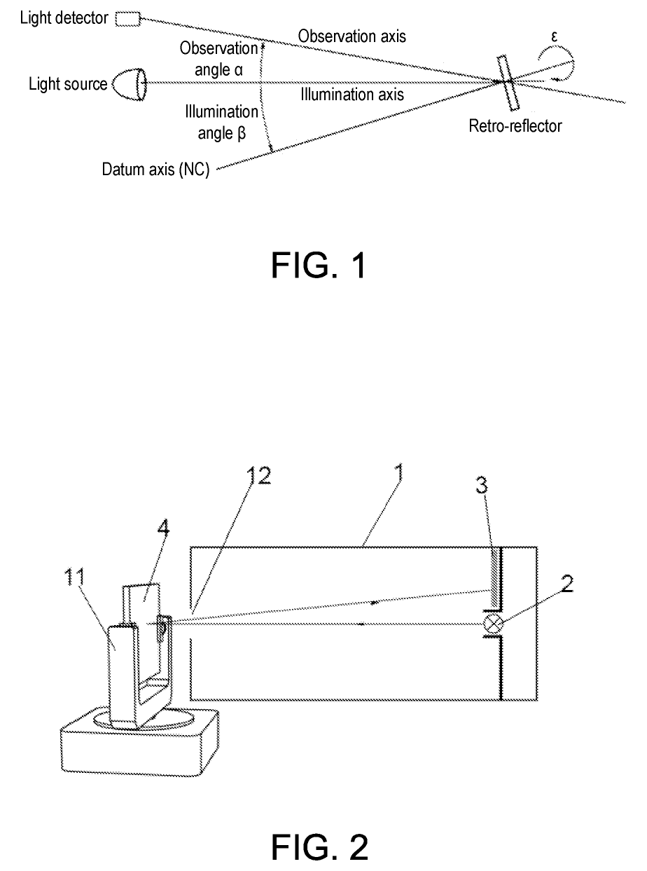

In the figures, 1-light shielding tube, 2-directional light source, 3-array detector, 4-measured sample, 5-perforated mirror, 6-diffusing screen, 7-imaging measurement unit, 8-mirror, 9-sample interface, 10-light blocking component, 11-rotating table, 12-sampling opening.

### DESCRIPTION OF THE EMBODIMENTS

### First embodiment

This embodiment discloses a retro-reflection measurement device, as shown in FIG. 2, including a light shielding tube 1 and a rotating table 11. A directional light source 2 and an array detector 3 are disposed inside the light shielding tube 1. A measured sample 4 is located outside the light shielding tube 1 and is disposed on the rotating table 11. Light beams emitted from the directional light source 2 directionally illuminate the measured sample 4. The array detector 3 is disposed next to or behind light emitted by the directional light source 2 and directly receives retro-reflection light beams from the measured sample 4. The rotating table 11 drives to change an illumination angle formed between a light beam axis of the directional light source 2 and a normal of the measured sample, to further implement measurement of a retro-reflection characteristic of the measured sample at a specific incident angle. An inner surface of the light shielding tube 1 is matte black, and a sampling opening 12 is provided at one end of the light shielding tube 1. The measured sample 4 is irradiated by the directional light source 2 through the sampling opening 12 and returns reflected light beams to be received and measured by the array detector. The directional light source 2 is a laser light source, and the array detector 3 uses a cooling technology. This device is suitable for measurement in laboratories, measurement in industrial production lines, and on-site measurement. Preferably, the retro-reflection measurement device further includes a standard light source with known light intensity distribution and for calibrating a response of the array detector. Before actual measurement, the response of the array detector is calibrated in advance using the standard light source with known light intensity distribution. The standard light source is placed at a position at which the measured sample is placed, and the standard light source is used for reverse irradiation and forms a response on the array detector. A response value of a pixel in the array detector is calibrated based on the known light intensity value, effectively correcting a pixel response error and further improving measurement accuracy and consistency. A calibrated array detector is used to measure a retro-reflection optical characteristic of the measured sample, and a measurement result obtained is relatively accurate.

This embodiment further provides a retro-reflection measurement method, including the following steps.

A1: Using, at a position of a measured sample, a standard light source with known spatial light intensity distribution for illumination and forming a response on an array detector, and calibrating a response value of a pixel in the array detector based on a known light intensity value; measuring position coordinates in space of and relative angular relationships between the array detector, the measured sample, and a directional light source, using a geometric optics principle and a triangle geometry relationship to calculate, for each pixel in the array detector, an angle between light reflected from the measured sample to the pixel and a light beam axis of the directional light source, namely, an observation angle, and establishing a correspondence between position coordinates of each pixel in the array detector and the observation angle.

A2: The directional light source uniformly illuminates the measured sample, and the array detector directly receives retro-reflected light from the measured sample and obtains retro-reflected light distribution. Specifically, the array detector faces the measured sample and receives the retro-reflected light from the measured sample by the pixel in the array detector.

A3: Measuring the retro-reflected light distribution in the measured sample, and calculating a retro-reflection luminescence intensity that varies with the observation angle based on the light distribution; taking an average or weighted average of the retro-reflection luminescence intensity within a specific aperture angle range around a specified observation angle, to obtain a retro-reflection luminescence intensity value at the specified observation angle; and deriving other retro-reflection parameters based on the retro-reflection luminescence intensity, including a retro-reflection luminescence intensity coefficient, a retro-reflection coefficient, and a retro-reflection brightness coefficient.

### Second embodiment

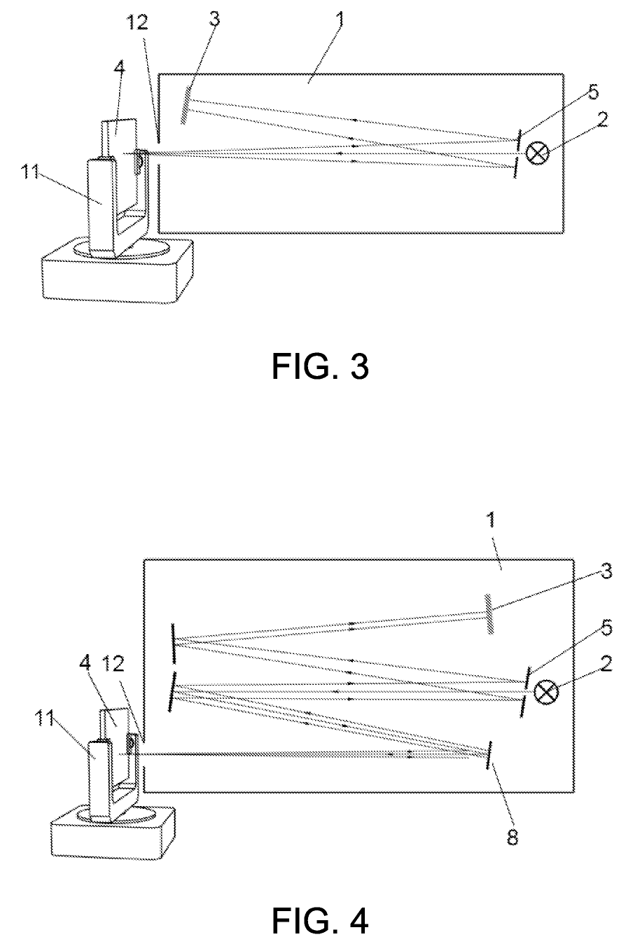

This embodiment discloses a retro-reflection measurement device, as shown in FIG. 3, including a light shielding tube 1 and a rotating table 11. A directional light source 2, a perforated mirror 5, and an array detector 3 are disposed inside the light shielding tube 1. A measured sample 4 is located outside the light shielding tube 1 and is disposed on the rotating table 11. The perforated mirror 5 is disposed in front of the directional light source 2, the perforated mirror 5 is located in an optical path from the directional light source 2 to the measured sample 4, and the perforated mirror 5 is also located in an optical path from the measured sample 4 to the array detector 3. Light beams emitted by the directional light source 2 penetrate the perforated mirror 5, and retro-reflected light beams emitted from the measured sample 4 are reflected by the perforated mirror 5 and then incident on the array detector 3. The rotating table 11 drives to change an illumination angle formed between a light beam axis of the directional light source 2 and a normal of the measured sample, to further implement measurement of a retro-reflection characteristic of the measured sample at a specific incident angle. An inner surface of the light shielding tube 1 is matte black, and a sampling opening 12 is provided at one end of the light shielding tube 1. The measured sample 4 is irradiated by the directional light source 2 through the sampling opening 12 and returns reflected light beams. In this embodiment, the array detector 3 is a two-dimensional array detector that uses a cooling technology. The directional light source 2 includes one or more different monochromatic LEDs that can be programmed and driven. The one or more monochromatic LEDs emit light separately or in combination. This device is suitable for rapid measurement on industrial production lines and on-site rapid measurement.

This embodiment further provides a retro-reflection measurement method, including the following steps.

B1: Using a collimated light source to irradiate a position of a measured sample in reverse at one or more angles, where an angle formed between a light beam axis of the collimated light source and a light beam axis of a directional light source for illuminating the sample is known, and then establishing a correspondence between position coordinates of each pixel in the array detector and an observation angle.

B2: Using a standard light source with known spatial light intensity distribution to irradiate the position of the measured sample in reverse, forming a response on the array detector, and calibrating a response value of the pixel in the array detector based on a known light intensity value.

B3: The directional light source emits light beams through a perforated mirror to directly illuminate the measured sample; retro-reflected light beams emitted from the measured sample are influenced by the perforated mirror, and are then incident on the array detector, the pixel in the array detector receives the retro-reflected light beams from the measured sample, and the array detector receives the retro-reflected light from the measured sample through the perforated mirror, to obtain retro-reflected light distribution; and calculating, based on the light distribution, a retro-reflection luminescence intensity that varies with an observation angle, through pre-calibration in B1 and B2, enabling position coordinates of the pixel in the array detector to be corresponding to the observation angle of retro-reflection, enabling a pixel response value of the array detector to be corresponding to the retro-reflection luminescence intensity, and then calculating a retro-reflection parameter of the measured sample at a specified observation angle. An average or weighted average of the retro-reflection luminescence intensity is taken within a specific aperture angle range around the specified observation angle, to obtain a retro-reflection luminescence intensity value at the specified observation angle; and other retro-reflection parameters are derived based on the retro-reflection luminescence intensity, including a retro-reflection luminescence intensity coefficient, a retro-reflection coefficient, and a retro-reflection brightness coefficient.

### Third embodiment

This embodiment discloses a retro-reflection measurement device, as shown in FIG. 4, including a light shielding tube 1 and a rotating table 11. A directional light source 2, a perforated mirror 5, a plurality of plane mirrors 8, and an array detector 3 are disposed inside the light shielding tube 1. A measured sample 4 is located outside the light shielding tube 1 and is disposed on the rotating table 11. The perforated mirror 5 is disposed in front of the directional light source 2, the perforated mirror 5 is located in an optical path from the directional light source 2 to the measured sample 4, and the perforated mirror 5 is also located in an optical path from the measured sample 4 to the array detector 3. Two mirrors 8 are also disposed on an optical path between the perforated mirror 5 and the measured sample 4, one mirror 8 is also disposed on an optical path between the perforated mirror 5 and the array detector 3, and the mirror 8 is a plane mirror. Light beams emitted from the directional light source 2 sequentially penetrate small holes in the perforated mirror 5, are then reflected by one or more mirrors along a folded optical path, and are incident on the measured sample 4. The retro-reflected light influenced by the measured sample 4 penetrates the one or more mirrors 8, and is finally incident on the array detector 3 through the perforated mirror 5. The rotating table 11 drives to change an illumination angle formed between a light beam axis of the directional light source 2 and a normal of the measured sample, to further implement measurement of a retro-reflection characteristic of the measured sample at a specific incident angle. An inner surface of the light shielding tube 1 is matte black, and a sampling opening 12 is provided at one end of the light shielding tube 1. The measured sample 4 is irradiated by the directional light source 2 through the sampling opening 12 and returns reflected light beams. This device is suitable for rapid measurement on industrial production lines and on-site rapid measurement.

This embodiment further provides a retro-reflection measurement method, including the following steps.

C1: Uniformly illuminating, by a directional light source, a measured sample with a specific aperture angle, and receiving, by an array detector, retro-reflected light from the measured sample, to obtain retro-reflected light distribution; including: the directional light source emits light beams through a perforated mirror, and the light beams from the directional light source penetrate one or more mirrors and then illuminate the measured sample; retro-reflected light beams emitted from the measured sample are influenced by the perforated mirror, penetrate one mirror, and are finally incident on the array detector.

C2: Calculating a retro-reflection luminescence intensity that varies with an observation angle based on the light distribution, including: performing pre-calibration, using a laser to irradiate a position of the measured sample in reverse at one or more angles, where an angle formed between a light beam axis of the laser and a light beam axis of the directional light source for illuminating the sample is known, and then calibrating a correspondence between position coordinates of a pixel and the observation angle based on a pixel response of the array detector; and using a sample of the same type with a known retro-reflection parameter as a standard sample, placing the standard sample at the position of the measured sample, and calibrating a pixel response value of the array detector based on a retro-reflection luminescence intensity of the standard sample; and then calculating a retro-reflection parameter of the measured sample at a specified observation angle.

C3: Driving the measured sample to rotate through a rotating table, changing an illumination angle formed between a normal of the measured sample and a light beam axis of the directional light source, and measuring the retro-reflection parameter based on step C1 and step C2 at two or more illumination angles, to obtain retro-reflection characteristics of the measured sample at different angles.

### Fourth embodiment

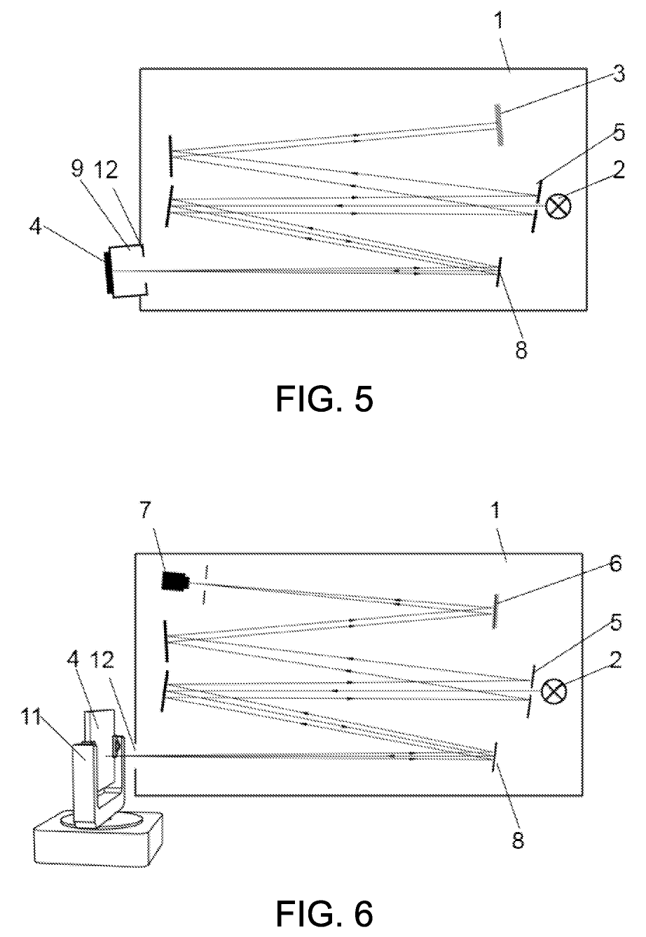

This embodiment discloses a retro-reflection measurement device, as shown in FIG. 5, including a light shielding tube 1 and a rotating table 11. A directional light source 2, a perforated mirror 5, a plurality of plane mirrors 8, and an array detector 3 are disposed inside the light shielding tube 1. An inner surface of the light shielding tube 1 is matte black. A sampling opening 12 is provided at one end of the light shielding tube 1, and one side of a sample interface 9 is connected to the sampling opening 12. A measured sample 4 is placed on the other side of the sample interface 9. The sample interface 9 includes two or more sample interfaces 9, and each sample interface 9 is provided so that a different angle is formed between a normal of the measured sample 4 and a light beam axis of the directional light source 2. The perforated mirror 5 is disposed in front of the directional light source 2, the perforated mirror 5 is located in an optical path from the directional light source 2 to the measured sample 4, and the perforated mirror 5 is also located in an optical path from the measured sample 4 to the array detector 3. Two mirrors 8 are also disposed on an optical path between the perforated mirror 5 and the measured sample 4, one mirror 8 is also disposed on an optical path between the perforated mirror 5 and the array detector 3, and the mirror 8 is a plane mirror. Light beams emitted from the directional light source 2 sequentially penetrate small holes in the perforated mirror 5, are then reflected by one or more mirrors along a folded optical path, and are incident on the measured sample 4. Retro-reflected light influenced by the measured sample 4 penetrates the one or more mirrors 8, is then reflected by the perforated mirror 5, and is finally incident on the array detector 3, so that measurement of a retro-reflection characteristic of the measured sample at a specific incident angle is implemented. The directional light source 2 is a halogen lamp, a high-intensity gas discharge lamp, an LED lamp, or a laser, or a combination of two or more types of the above light sources.

This embodiment further provides a retro-reflection measurement method, including the following steps.

D1: Uniformly illuminating, by a directional light source, a measured sample, and receiving, by an array detector, retro-reflected light from the measured sample, to obtain retro-reflected light distribution; including: the directional light source emits light beams through a perforated mirror, and the light beams from the directional light source penetrate more than two mirrors and are then illuminated on the measured sample; retro-reflected light beams emitted from the measured sample are influenced by the two mirrors and one perforated mirror, penetrate one mirror, and are finally incident on the array detector.

D2: Calculating, based on the light distribution, a retro-reflection luminescence intensity that varies with an observation angle, including: through pre-calibration, enabling position coordinates of a pixel in the array detector to be corresponding to the observation angle of retro-reflection, enabling a pixel response value of the array detector to be corresponding to the retro-reflection luminescence intensity, and then calculating a retro-reflection parameter of the measured sample at a specified observation angle.

D3: Replacing different sample interfaces, changing an illumination angle formed between a normal of the measured sample and a light beam axis of the directional light source, or enabling a different angle to be formed between the normal of the measured sample and the light beam axis of the directional light source, and measuring a retro-reflection parameter at different angles based on step D1 and step D2, to obtain retro-reflection characteristics of the measured sample at different angles.

### Fifth embodiment

This embodiment discloses a retro-reflection measurement device, as shown in FIG. 6, including a light shielding tube 1 and a rotating table 11. A directional light source 2, a perforated mirror 5, a plurality of plane mirrors 8, a diffusing screen 6, and an imaging measurement unit 7 are disposed inside the light shielding tube 1. A measured sample 4 is located outside the light shielding tube 1 and is disposed on the rotating table 11. The perforated mirror 5 is disposed in front of the directional light source 2, the perforated mirror 5 is located in an optical path from the directional light source 2 to the measured sample 4, and the perforated mirror 5 is also located in an optical path from the measured sample 4 to the imaging measurement unit 7. Two mirrors 8 are also disposed on an optical path between the perforated mirror 5 and the measured sample 4, one mirror 8 is also disposed on an optical path between the perforated mirror 5 and the array detector 3, and the mirror 8 is a plane mirror. The diffusing screen 6 is located on a reflection optical path of the perforated mirror 5. Light beams emitted from the directional light source 2 sequentially penetrate small holes in the perforated mirror 5, are reflected by one or more mirrors along a folded optical path, and are then incident on the measured sample 4. The retro-reflected light influenced by the measured sample 4 penetrates the one or more mirrors 8, is then reflected by the perforated mirror 5, and is finally incident on the diffusing screen. The array detector 3 is located in one imaging measurement unit 7, and the imaging measurement unit 7 further includes an imaging lens. The imaging measurement unit 7 is disposed facing the diffusing screen 6. The imaging lens images a light spot image on the diffusing screen 6 into the array detector 3. The array detector 3 in this embodiment is a two-dimensional planar array detector. The rotating table 11 drives to change an illumination angle formed between a light beam axis of the directional light source 2 and a normal of the measured sample, to further implement measurement of a retro-reflection characteristic of the measured sample at a specific incident angle.

This embodiment further provides a retro-reflection measurement method, including the following steps.

E1: A directional light source uniformly illuminates a measured sample, and a two-dimensional planar array detector in an imaging measurement unit is used to collect light distribution generated by retro-reflection of a measured sample; including: the directional light source emits light beams through a perforated mirror, and the light beams from the directional light source penetrate more than two mirrors and are then illuminated on the measured sample; retro-reflected light beams emitted from the measured sample are influenced the two mirrors and one perforated mirror, penetrate one mirror, and are finally incident on a diffusing screen, an imaging lens in the imaging measurement unit projects light spot information on the diffusing screen onto an image plane of the two-dimensional planar array detector, and obtains light distribution generated by the retro-reflection of the measured sample.

E2: Calculating, based on the light distribution, a retro-reflection luminescence intensity that varies with an observation angle, including: through pre-calibration, enabling position coordinates of a pixel in the two-dimensional planar array detector to be corresponding to the observation angle of retro-reflection, enabling a pixel response value of the two-dimensional planar array detector to be corresponding to the retro-reflection luminescence intensity, and then calculating a retro-reflection parameter of the measured sample at a specified observation angle.

E3: Driving the measured sample to rotate through a rotating table, changing an illumination angle formed between a normal of the measured sample and the light beam axis of the directional light source, and measuring the retro-reflection parameter based on step E1 and step E2 at two or more illumination angles, to obtain retro-reflection characteristics of the measured sample at different angles.

### Sixth embodiment

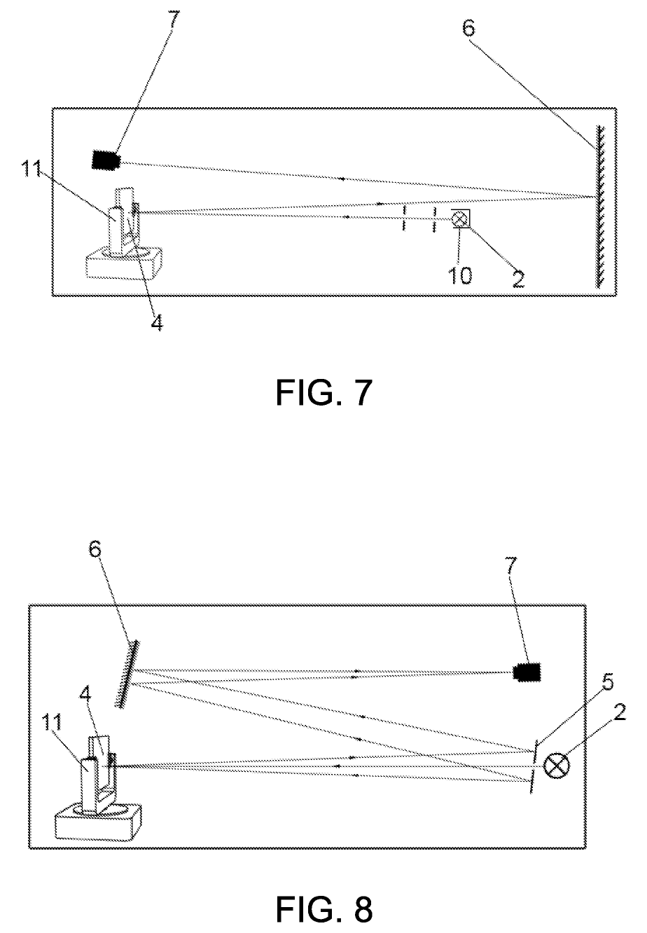

This embodiment discloses a retro-reflection measurement device, as shown in FIG. 7, including a light measurement darkroom, and a rotating table 11, a directional light source 2, a diffusing screen 6, a light blocking component 10, and an imaging measurement unit 7 are provided in the light measurement darkroom. A measured sample 4 is disposed on the rotating table 11, and the diffusing screen 6 is disposed on a side of the directional light source 2. The diffusing screen 6 faces the measured sample 4 on the rotating table 11. The array detector 3 is located in one imaging measurement unit 7, and the imaging measurement unit 7 further includes an imaging lens. The imaging measurement unit 7 is disposed facing the diffusing screen 6, and a measurement field of view of the imaging measurement unit 7 avoids light beams emitted from the directional light source 2, and collects only light spot information on the diffusing screen 6. The light beams emitted from the directional light source 2 are directionally irradiated to the measured sample 4, and the light blocking component 10 is configured to block the light beams emitted from the directional light source 2 from being directly incident on the diffusing screen 6. Retro-reflected light from the measured sample 4 is projected onto the diffusing screen 6, to form light spots. The imaging lens images a light spot image on the diffusing screen 6 onto the array detector 3, thereby implementing measurement of a retro-reflection characteristic of the measured sample at a specific incident angle. The array detector 3 in this embodiment is a two-dimensional planar array detector. This device is suitable for measurement in a laboratory.

This embodiment further provides a retro-reflection measurement method, including the following steps. A directional light source emits light beams directly onto a measured sample. Retro-reflected light beams emitted from the measured sample are incident on a diffusing screen, and an imaging measurement unit is aligned with the diffusing screen. An imaging lens projects light spot information on the diffusing screen onto an image plane of a two-dimensional planar array detector, to obtain light distribution generated by retro-reflection of the measured sample. Through pre-calibration, position coordinates of the pixel in the two-dimensional planar array detector are corresponding to an observation angle of retro-reflection, a pixel response value of the two-dimensional planar array detector is corresponding to a retro-reflection luminescence intensity, and then a retro-reflection parameter of the measured sample is calculated at a specified observation angle. The measured sample is driven to rotate through a rotating table, an illumination angle formed between a normal of the measured sample and a light beam axis of the directional light source is changed, and the retro-reflection parameter is measured at two or more illumination angles, to obtain retro-reflection characteristics of the measured sample at different angles.

### Seventh embodiment

This embodiment discloses a retro-reflection measurement device, as shown in FIG. 8, including a light measurement darkroom, and a rotating table 11, a directional light source 2, a diffusing screen 6, a perforated mirror 5, and an imaging measurement unit 7 are provided in the light measurement darkroom. A measured sample 4 is disposed on the rotating table 11. The perforated mirror 5 is disposed in front of the directional light source 2, the perforated mirror 5 is located in an optical path from the directional light source 2 to the measured sample 4, and the perforated mirror 5 is also located in an optical path from the measured sample 4 to the diffusing screen 6. Light beams emitted by the directional light source 2 penetrate small holes in the perforated mirror 5 and are incident on the measured sample 4. Retro-reflected light beams emitted from the measured sample 4 are reflected by the perforated mirror 5 and then incident on the diffusing screen 6. The imaging measurement unit 7 is disposed facing the diffusing screen 6 and includes an imaging lens and an array detector. The imaging lens images a light spot image on the diffusing screen 6 into the array detector 3, thereby implementing measurement of a retro-reflection characteristic of the measured sample. This device is suitable for measurement in a laboratory.

This embodiment further provides a retro-reflection measurement method, including the following steps. A directional light source emits light beams through a perforated mirror to be directly irradiated onto a measured sample; and retro-reflected light beams emitted from the measured sample are influenced by the perforated mirror and then incident on a diffusing screen, and an imaging measurement unit is aligned with the diffusing screen. An imaging lens projects light spot information on the diffusing screen onto an image plane of an array detector, to obtain light distribution generated by retro-reflection of the measured sample. Through pre-calibration, position coordinates of a pixel in the array detector are corresponding to an observation angle of retro-reflection, a pixel response value of the array detector is corresponding to a retro-reflection luminescence intensity, and then a retro-reflection parameter of the measured sample is calculated at a specified observation angle.

Specific implementations of the present invention have been described above with reference to the accompanying drawings, but those skilled in the art should understand that the above embodiments are only for illustration and not limiting the scope of the present invention. Those skilled in the art should understand that modifications can be made to the above embodiments without departing from the scope and spirit of the present invention. The scope of protection of the present invention is limited by the appended claims.

What is claimed is:

1. A retro-reflection measurement method, comprising the following steps:
S1: uniformly illuminating, by a directional light source, a measured sample, and receiving, by an array detector, retro-reflected light from the measured sample, to obtain retro-reflected light distribution;
S2: calculating, based on the retro-reflected light distribution, a retro-reflection luminescence intensity that varies with an observation angle, comprising: enabling position coordinates of a pixel in the array detector to be corresponding to the observation angle of retro-reflection, enabling a pixel response value of the array detector to be corresponding to the retro-reflection luminescence intensity, and then calculating a retro-reflection parameter of the measured sample at a specified observation angle.

2. The retro-reflection measurement method according to claim 1, wherein in step S1, the array detector is used to directly collect and measure the retro-reflected light distribution, and the array detector directly receives the retro-reflected light from the measured sample or receives the retro-reflected light from the measured sample through a mirror.

3. The retro-reflection measurement method according to claim 1, wherein in step S1, the array detector is located in an imaging measurement unit, a diffusing screen is disposed in a retro-reflection optical path, retro-reflection light beams are irradiated onto the diffusing screen, and an imaging lens in the imaging measurement unit projects light spot information on the diffusing screen onto an image plane of the array detector.

4. The retro-reflection measurement method according to claim 2, wherein in step S2, an average or weighted average of the retro-reflection luminescence intensity is taken within a specific aperture angle range around the specified observation angle, to obtain a retro-reflection luminescence intensity value at the specified observation angle; and other retro-reflection parameters are derived based on the retro-reflection luminescence intensity, comprising a retro-reflection luminescence intensity coefficient, a retro-reflection coefficient, and a retro-reflection brightness coefficient.

5. The retro-reflection measurement method according to claim 1, wherein in step S1, the directional light source emits light beams through a perforated mirror, and the light beams from the directional light source directly illuminate the measured sample or penetrate one or more mirrors and then illuminate the measured sample; retro-reflected light beams emitted from the measured sample are influenced by the perforated mirror, and are finally incident on the array detector.

6. The retro-reflection measurement method according to claim 1, wherein in step 2, a correspondence between the position coordinates of the pixel in the array detector and the observation angle is calibrated through a spatial geometric positional relationship; a collimated light source is used to irradiate a position of the measured sample in reverse at one or more angles, wherein an angle formed between a light beam axis of the collimated light source and a light beam axis of the directional light source for illuminating the sample is known, and then a correspondence between the position coordinates of the pixel and the observation angle is calibrated based on a pixel response in the array detector; or a correspondence between the position coordinates of the pixel in the array detector and the observation angle is calibrated in combination with the two methods.

7. The retro-reflection measurement method according to claim 1, wherein step 2 further comprises: using a standard light source with known spatial light intensity distribution to irradiate the position of the measured sample in reverse, forming a response on the array detector, and calibrating a response value of the pixel in the array detector based on a known light intensity value.

8. The retro-reflection measurement method according to claim 1, wherein a sample of the same type with a known retro-reflection parameter is used as a standard sample, the standard sample is placed at the position of the measured sample, and the pixel response value of the array detector is calibrated based on a retro-reflection luminescence intensity of the standard sample.

9. The retro-reflection measurement method according to claim 1, wherein an illumination angle formed between a normal of the measured sample and a light beam axis of the directional light source is adjustable, and the retro-reflection parameter is measured based on step S1 and step S2 at two or more illumination angles.

10. A retro-reflection measurement device using the method according to claim 1, comprising a light shielding tube, wherein the light shielding tube is provided with a sampling opening for placing the measured sample, the directional light source and the array detector are disposed inside the light shielding tube, light beams emitted from the directional light source directionally illuminate the sampling opening, and the array detector is disposed on a retro-reflection optical path to receive retro-reflection optical beams of the measured sample.

11. The retro-reflection measurement device according to claim 10, wherein an imaging measurement unit and a diffusing screen are also disposed in the light shielding tube, and the diffusing screen is located on the retro-reflection optical path, the array detector is located in the imaging measurement unit, the imaging measurement unit further comprises an imaging lens, the imaging measurement unit is disposed facing the diffusing screen, and the imaging lens images a light spot image on the diffusing screen into the array detector.

12. The retro-reflection measurement device according to claim 10, wherein inside the light shielding tube, a perforated mirror is disposed in front of the directional light source, light beams emitted by the directional light source are emitted through small holes in the perforated mirror, and the array detector is disposed on a reflection optical path of the perforated mirror.

13. The retro-reflection measurement device according to claim 11, wherein one or more mirrors are further disposed on an optical path between the perforated mirror and the sampling opening, and the mirror is a plane mirror, a concave mirror, or a convex mirror.

14. The retro-reflection measurement device according to claim 10, wherein inside the light shielding tube, the directional light source is disposed between the array detector and the sampling opening, and a photosensitive unit of the array detector is disposed facing the sampling opening.

15. The retro-reflection measurement device according to claim 10, comprising two or more sample interfaces, wherein one side of the sample interface is connected to the sampling opening, the measured sample is placed on the other side of the sample interface, and each sample interface is provided so that a different angle is formed between a normal of the measured sample and a light beam axis of the directional light source.

16. A retro-reflection measurement device using the method according to claim 1, comprising a rotating table, the directional light source, a diffusing screen, and an imaging measurement unit, wherein the imaging measurement unit comprises an imaging lens and the array detector; the rotating table and the directional light source are relatively disposed in a darkroom; and the measured sample is installed on the rotating table, light beams emitted by the directional light source illuminate the measured sample, the diffusing screen receives retro-reflected light from the measured sample, and the imaging measurement unit faces the diffusing screen, wherein the imaging lens images light spots on the diffusing screen onto the array detector.

17. The retro-reflection measurement device according to claim 16, wherein one or more mirrors are further comprised in an optical path from the directional light source to the measured sample, light beams emitted from the directional light source sequentially penetrate small holes in a perforated mirror, are then reflected by the one or more mirrors along a folded optical path, and are incident on the measured sample, and the retro-reflected light influenced by the measured sample penetrates the one or more mirrors, and is then incident on the diffusing screen through the perforated mirror.

18. The retro-reflection measurement device according to claim 16, wherein a light blocking component is disposed between the diffusing screen and the directional light source to block light beams emitted by the directional light source from being directly incident on the diffusing screen; and a measurement field of view of the imaging measurement unit avoids the light beams emitted by the directional light source and collects only light spot information on the diffusing screen.

19. The retro-reflection measurement method according to claim 2, wherein in step S1, the directional light source emits light beams through a perforated mirror, and the light beams from the directional light source directly illuminate the measured sample or penetrate one or more mirrors and then illuminate the measured sample; retro-reflected light beams emitted from the measured sample are influenced by the perforated mirror, and are finally incident on the array detector.

20. The retro-reflection measurement method according to claim 3, wherein in step S1, the directional light source emits light beams through a perforated mirror, and the light beams from the directional light source directly illuminate the measured sample or penetrate one or more mirrors and then illuminate the measured sample; retro-reflected light beams emitted from the measured sample are influenced by the perforated mirror, and are finally incident on the array detector.
